(19) United States
(12) Patent Application Publication
(10) Pub. No.: US 2016/0047103 A1
(43) Pub. Date: Feb. 18, 2016

(54) GROUND COMPACTING APPARATUS

(71) Applicant: Samuel S. Pratt, Bedford, PA (US)

(72) Inventor: Samuel S. Pratt, Bedford, PA (US)

(21) Appl. No.: 14/461,807

(22) Filed: Aug. 18, 2014

(51) Int. Cl. E02D 3/026; E01C 19/23; A01B 29/00

(52) U.S. Cl. CPC E02D 3/026; E02D 3/0265; A01B 29/00; E01C 19/23

(57) ABSTRACT

An apparatus for compacting and forming depressions along a tract of ground being worked generally consisting of a support means; a drum mounted on the support means for rotation movement about an axis thereof; and a liner formed of a material having earth adherent retarding properties mounted on a cylindrical surface of the drum, having a bay section disposed on the cylindrical surface and a plurality of outwardly projecting sections.

This invention relates to an apparatus for compacting recently disturbed ground on slopes and more particularly to such an apparatus that not only compacts the ground but forms impressions in the compacted ground in which seeds of various sowed ground covers may be trapped, thus facilitating germination while minimizing erosion. This invention further contemplates such an apparatus which is effective in neither removing nor otherwise disturbing the pound being compacted and conditioned for seeding, and preventing erosion.

### BACKGROUND OF THE INVENTION

In the construction of roads, the general procedure is to grade the roadway, lay down a subgrade such as an aggregate, pave the subgrade and then finish grade, compact and seed the shoulders of the road. Often, the shoulders of the road will be at the same elevation as the road but on many occasions, the shoulder will be sloped from the road. In compacting such shoulders and conditioning them for seeding, various types of compacting machines have been used. Such machines typically have consisted of crawler tractors that were run up and down such slopes so as to provide both compaction and consistent surface roughening for preventing erosion and facilitating seed germination.

In the prior art, there has been developed a wide variety of devices for compacting and otherwise conditioning various tracks of ground including the shoulders of roads. Examples of such compactors are illustrated and described in U.S. Pat. No. 953,546 disclosing a compactor incorporated as a wheel unit of a vehicle, U.S. Pat. Nos. 827,329; 895,230; 4,237,984 and 4,339,908 disclosing towed typed compactors and U.S. Pat. No. 278,368 disclosing a compactor attached to the dipper stick of a excavating machine.

Although such prior art devices would appear to adequately compact and form depressions in the ground for seeding purposes, it has been found that such devices are deficient in operation in that the configurations and compositions of the means provided for forming the depressions tend to cause portions of earth being compacted and impressed to adhere to or lodge in the impression forming components of such devices. Some of the prior art devices have addressed such occurrence but further have been found not to be sufficiently adequate in performance. Accordingly, it is the principal object of the present invention to provide an apparatus for compacting and forming depressions in a tract of ground such as the shoulder of a roadway, preparatory to sowing ground cover seeds, which is highly effective in compacting and forming depressions in the ground without removing or otherwise disturbing the ground being worked.

### SUMMARY OF THE INVENTION

The principal object of the present invention is achieved by providing a ground compactor generally consisting of a support means, a drum mounted on the support means for rotational movement about an axis thereof and a liner comprising a non-earth adhering material such as a non-adhering polymer, mounted on a cylindrical surface of the drum, having a base portion disposed on the cylinder surface on the drum and a plurality of outwardly projecting portions. Preferably, the liner is formed of a material consisting of a crosslinked high density polyethylene material or a polytetrafluoroethylene material. The liner may consist of a single piece of material which may be fitted and secured onto the cylindrical surface of the drum or may consist of a plurality of segments disposed about the periphery of cylindrical surface, each individually secured to the drum or a material sprayed on the drum. In effect, the nature of the material from which the liner is formed is such that it functions to preclude the adherence of loose earth to either cling to components of the liner or lodge between successive projecting portions of the liner. The apparatus may be formed as a unit to be towed by a tractor, comprise a wheel unit of a land vehicle or be attached to the dipper stick of an excavating machine.

### BRIEF DESCRIPTION OF THE DRAWINGS

FIG. 1 of the drawings is perspective view of an apparatus embodying the present invention, in a form permitting it to be attached to the dipper stick of a excavating machine;

FIG. 2 is a side elevational view of the apparatus shown in FIG. 1 attached to the dipper stick of an excavating machine, having a portion thereof broken away, illustrating the apparatus in a first position of a sequence of positions in which the ground on a sloped surface is being compacted and formed with depressions for a subsequent seeding operation;

FIG. 2A is a view similar to the view shown in FIG. 2, illustrating the machine and apparatus in a subsequent position, advancing the apparatus further up the slope being worked;

FIG. 2B is a view similar to the view shown in FIGS. 2 and 2A, further illustrating the machine and apparatus in a still further position along the slope being worked;

FIG. 3 is a side elevational view of another embodiment of the invention in the form of a unit towed by a tractor;

FIG. 4 is a still further embodiment of the invention in the form of a wheel unit of a land vehicle;

FIG. 5 is an enlarged, side elevational view of the apparatus illustrated in any of the previous views, illustrating the manner in which a liner of the apparatus is fitted onto a drum thereof;

FIG. 6 is a view similar to the view shown in FIG. 5, illustrating a different form of liner fitted onto the drum thereof;

FIG. 6A is an enlarged, perspective view of a segment of the liner shown in FIG. 6, having a portion thereof broken away;

FIG. 7 is a view similar to the view shown in FIG. 5, illustrating a still different form of liner fitted onto the drum thereof; and

FIG. 7A is an enlarged, perspective view of a segment of the liner shown in FIG. 7, having a portion thereof broken away.

### DETAILED DESCRIPTION OF PREFERRED EMBODIMENT OF THE INVENTION

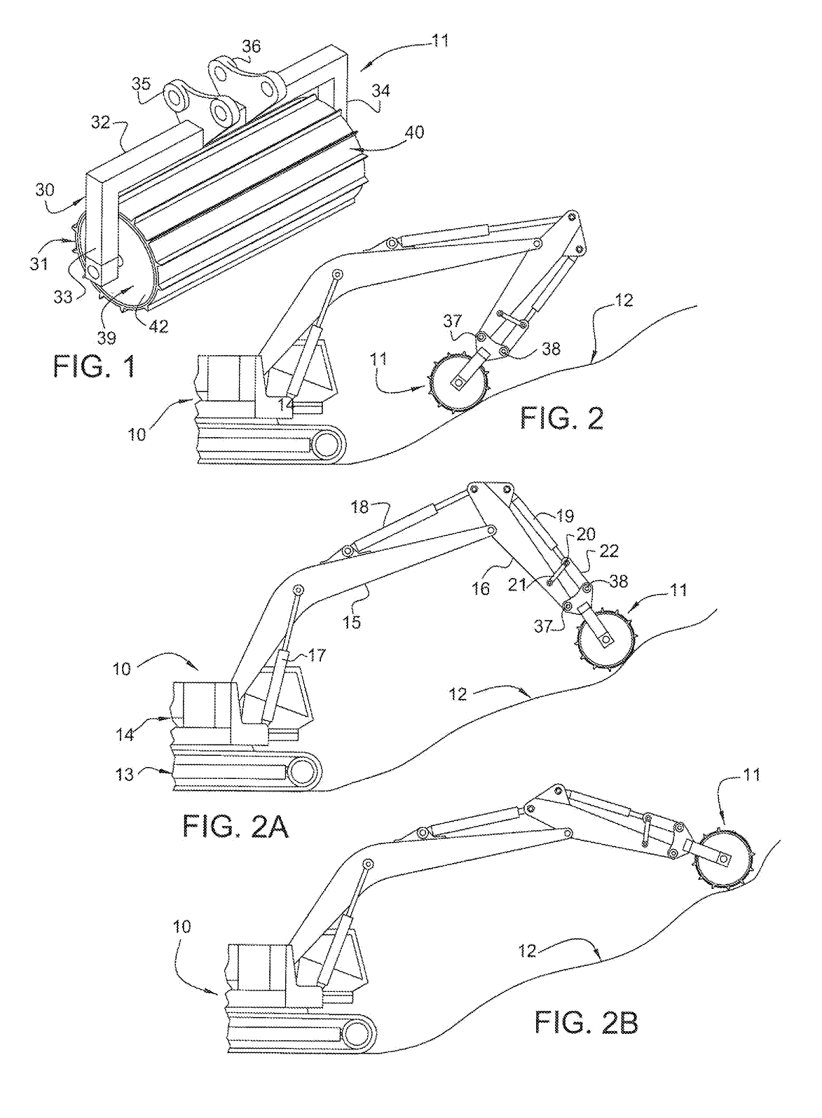

Referring to FIGS. 1 through 2A of the drawings, there is illustrated an excavating machine 10 having attached thereto an apparatus 11 which may be manipulated to a compact and form depressions along a tract of slopped ground 12. The excavating machine is of a conventional construction including a lower, mobile frame assembly, an upper frame assembly 14, mounted on the lower frame assembly for rotational movement about a vertical axes, a boom 15 pivotally connected at a lower end thereof to upper frame assembly 14 for pivotal movement in a vertical plane and a dipper stick 16 pivotally connected to the free end of the boom for pivotal movement for the same plane as the boom. A pair of hydraulic cylinder assemblies 17 operatively interconnect the upper frame assembly and boom 15 for pivoting the boom relative to the upper frame assembly, a hydraulic cylinder assembly 18 operatively interconnects intermediate portions of boom 15 and an end of dipper stick 16 and a hydraulic cylinder assembly 19 operatively interconnects a set of brackets at a rear end of the dipper stick and a connecting pin 20 which connects a pair of support links 21 and a pair of actuating links 22.

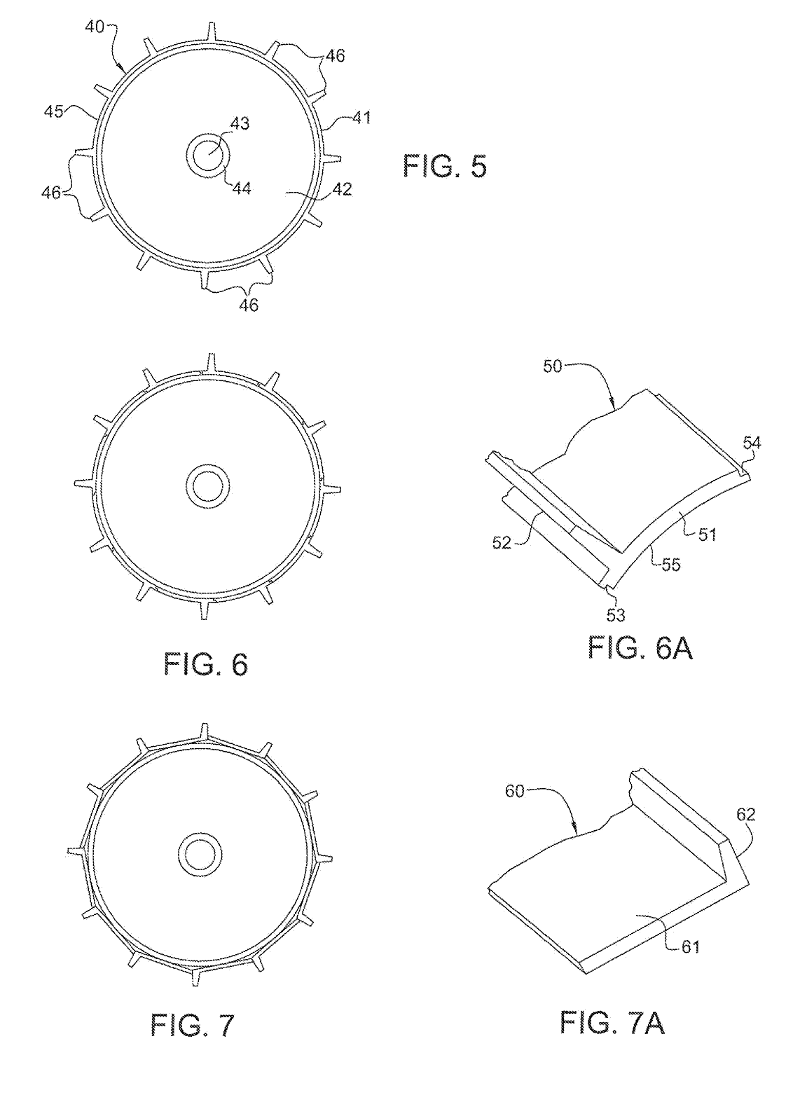

As best shown in FIGS. 1 and 5, compactor apparatus 11 basically consists of a support yoke 30 and a roller 31. Support yoke 30 includes a transversely disposed beam portion 32 and a pair of depending leg portions 33 and 34. Mounted between the ends of the transversely disposed beam portion 32 is a set of attachment brackets 35 and 36 provided with a pair of aligned openings for receiving a pair of connecting pins 37 and 38 for detachably connecting the compactor apparatus to dipper stick 16 and actuating links 22 of the excavating machine as shown in FIG. 2. Roller 31 consists of a drum 39 and a liner 40 fitted onto the drum. Drum 39 is provided with a cylindrical surface 41 and a pair of end walls 42, 42 provided with an axially disposed shaft 43 journaled at the ends thereof in a set of bearings 44 mounted on the lower ends of leg portions 33 and 34 of the support yoke. The drum may be formed of any sturdy metal, preferably steel. Liner 40 consists of a cylindrical portion 45 and a set of transversely disposed circumferentially spaced cleat portions 46. The liner is formed of a material having a composition which retards adherence of soil intended to be compacted on the ground being worked by the apparatus. Examples of such a material are a rotational molding crosslinkable, high density polyethylene manufactured by the Chevron Phillips Chemical Company of The Woodlands, Tex., sold under the trademark MARLAX and identified by Product No. CL-200YB, having a high impact strength, providing long term outdoor weathering and containing an internal mold release, a crosslinkable, high density polyethylene manufactured by the Exxon Mobil Chemical Company of Houston, Tex., sold under the trademark PAXTON and a crosslinkable, high density polyethylene manufactured by A. Schulman, Inc. Of Akron Ohio, sold under the trademark SCHULNICK and identified by Product No. XL350. The liner is fitted over the cylindrical surface of the drum and secured thereto by an adhesive or by threaded fasteners. Other non-adherent polymers including polytetrafluoroethylene (PTFE), manufactured and sold by the DuPont Company under the trademark TEFLON may be used as a liner material.

In lieu of an integral liner as shown in FIG. 5, such liner may be formed of a plurality of segments 50 as shown in FIGS. 6 and 6A or segments 60 as shown in FIGS. 7 and 7A. Each of segments 50 consists of an elongated substantially rectangular section 51 provided with an integrally molded cleat portion 52 formed along an elongated side of the segment. Such segments are mounted about the circumference of the cylindrical surface of the drum and are individually secured to the drum with an adhesive or threaded fasteners. To facilitate the mounting of such segments on the surface of the drum, one elongated edge portion of the base section 51 of each segment is provided with a protruding lip portion 53 and the opposite, elongated edge portion of base section 51 is provided with a recess 54 adapted to receive a lip portion 53 of an adjacent, successive segment to provide a liner comparable to integrally form liner 40, as shown in FIG. 6. Each of the segments 50 is formed of a material similar to the material of which liner 40 is formed. To further accommodate the mounting of segments 50 on the cylindrical surface on the drum, the base section 51 of each segment 50 is formed with a radius of curvature similar or substantially similar to the radius of the cylindrical surface of the drum or perhaps simply the lower surface 55 of the segment may be so formed.

Each of segments 60 is similar in construction and function to segment 50. Each of such segments includes any elongated, rectangularly configured based section 61 and a cleat section 62 formed integrally with base section 61 along an elongated edge thereof. Each of segments 60 also is formed of a material having a composition similar to the composition of liner 40. As shown in FIG. 7 a plurality of segments 60 are mounted on the cylindrical surface of the drum extending transversely and disposed about the circumference of such surface to provide a liner configuration similar to the configuration of liner 40. Such segments also are secured to the drum by means of an adhesive or threaded fasteners.

The spacing of cleat portions 46 of liner 40 and the widths of segments 50 and 60 may be of any desired dimension, depending on the spacing of the depressions to be made in the tract of ground being compacted. Preferably, such spacing and widths would be sufficient to compliment the effect of the nature of the material of liner 40 and segments 50 and 60 in retarding adherence of soil being worked by the apparatus and the possible lodging of material between successive cleat portions of such linings.

The embodiments of the invention may be constructed by first forming the drum, applying the liner to the cylindrical surface of the drum, forming the support yoke with the mounting brackets and then connecting the drum with the applied liner on the support frame so that the drum is supported by the support yoke and free to rotate about the axis thereof. As previously indicated, in the embodiment shown in FIG. 5, the liner is first formed by rotational molding, fitted onto the cylindrical surface of the drum and secured thereto by an adhesive r threaded fasteners. In the embodiments shown in FIGS. 6 and 7, the segments initially are molded and then positioned on the cylindrical surface of the drum about the circumference thereof and secured thereto by an adhesive or threaded fasteners.

In the use of the apparatus as shown in FIG. 1, the apparatus is merely attached to the end of the dipper stick of the excavating machine with a set of connecting pins 37 and 38, and the machine is operated in the conventional manner to roll the roller drum along a tract of ground such as slope 12 to compact the soil and form a series of spaced depressions in the ground which subsequently serve to capture and trap seeds of a ground cover being a sown for the purpose of enhancing the germination of such seeds.

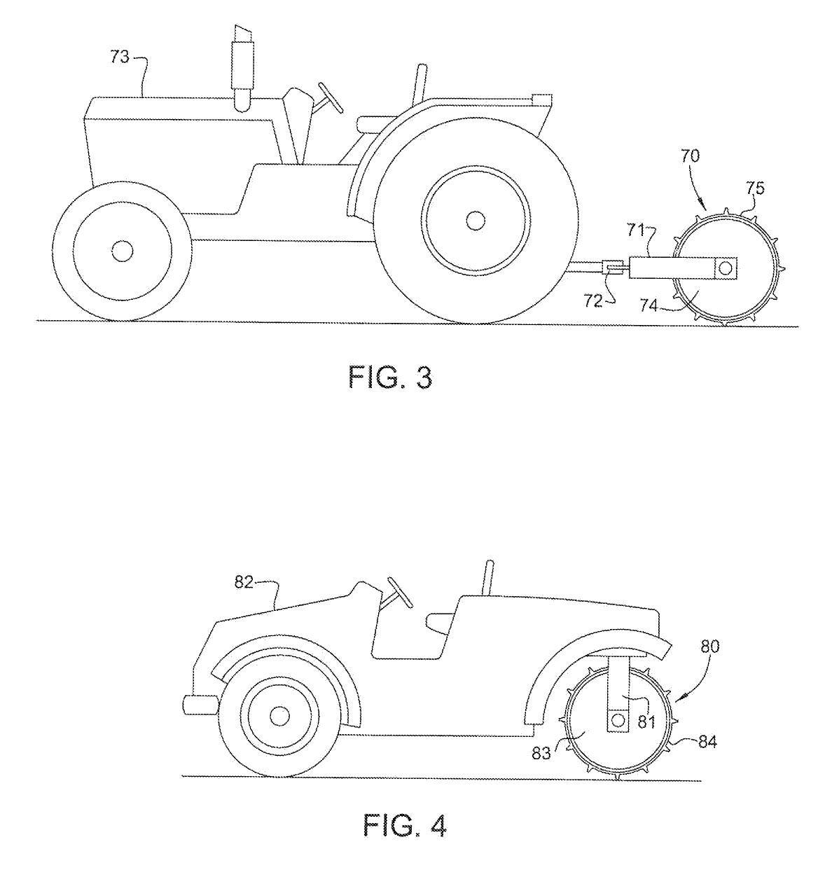

In addition to the apparatus being used as an attachment for the dipper stick of an excavating machine as shown in FIG. 2, the apparatus may be towed from a tractor as shown FIG. 3 or formed as a wheel unit as shown in FIG. 4. The embodiment shown in FIG. 3 includes an apparatus 70 comparable to apparatus 11 shown in FIG. 1, provided with a support yoke 71 adapted to be connected to a hitch 72 of a tractor 73, a drum 74 rotatably connected to leg portions of support yoke 71 and a liner 75 fitted onto and secured to the cylindrical surface of the drum. The embodiment shown in FIG. 4 includes an apparatus 80 comparable to apparatus 11 shown in FIG. 1 which includes a support yoke 81 secured to the chassis of a land vehicle 82, a drum 83 rotatably mounted on the support yoke and a liner 84 fitted and rigidly secured to the cylindrical surface of the drum. Preferably, vehicle 82 would be of a front wheel drive and apparatus 80 would function as a wheel unit compacting and indenting the ground surface as the vehicle is advanced.

In each of the embodiments described, the apparatus is functional in compacting and forming depressions in the ground being worked, without any of the soil traversed being caused to cling to the liner of the apparatus. The result of the ground being so worked would be a compacted surface provided with spaced depressions which would accommodate the seeding of the tract having thus been prepared. Depending on the equipment used with the apparatus, it may be utilized to compact and form depressions on sloped terrain. The worked surface would be neatly compacted with spaced depressions for capturing seeds and preventing erosion, and the ground will not otherwise be disturbed and no material will be removed by the apparatus.

From the foregoing detailed description, it will be evident that there are a number of changes, adaptations and modifications of the present invention, which come within the province of those persons having ordinary skill in the art to which the aforementioned invention pertains. However, it is intended that all such variations not departing from the spirit of the invention be considered as within the scope thereof as limited solely by the appended claims.

I claim:

1. An apparatus for compacting and forming depressions along a tract of ground being worked, comprising:
a support means;
a drum mounted on said support means for rotational movement about an axis thereof; and
a liner formed of a material having earth adherent retarding properties mounted on a cylindrical surface of said drum, having a base section disposed on said cylindrical surface and a plurality of outwardly projecting sections.

2. An apparatus according to claim 1 wherein said liner material comprises a non-earth adhering polymer.

3. An apparatus according to claim 1 wherein said liner material comprises a cross linkable, high density polyethylene.

4. An apparatus according to claim 1 wherein said liner is formed of a rotationally molded, crosslinked high density polyethylene.

5. An apparatus according to claim 1 wherein said outwardly projecting sections of said liner comprise a plurality of circumferentially spaced cleat sections.

6. An apparatus according to claim 1 wherein said support means is mountable on the dipper stick of an excavator machine.

7. An apparatus according to claim 1 wherein said support means is mountable on a land vehicle as a wheel unit.

8. An apparatus according to claim 1 wherein said support means is attachable to a land vehicle for being towed thereby.

9. An apparatus accordingly to claim 1 wherein said liner comprises a plurality of segments disposed about the circumference of said cylindrical surface of said drum, each of said segments including a base section attached to said cylindrical surface of said drum and a projecting portion relative to said base section.

10. An apparatus according to claim 9 wherein each of said segments is formed of a non-earth adhering polymer.

11. An apparatus according to claim 9 wherein each of said segments is formed of a crosslinked, high density polyethylene.

12. An apparatus according to claim 9 wherein each of said segments is adhesively attached to said cylindrical surface of said drum.

13. An apparatus according to claim 9 wherein each of said segments is secured to said cylindrical surface of said drum by means of threaded fasteners.

14. An apparatus according to claim 9 wherein each of said segments has a substantially L-shaped cross sectional configuration.

15. An apparatus according to claim 9 wherein said projecting section of each of said segments is disposed between ends of said base section thereof.

16. An apparatus according to claim 9 wherein the base section of each of said segments includes a first mating edge having a recessed portion and a second mating edge having a lip portion, and wherein the lip portion of the base section of each of said sections is received within the recessed portion of the base section of a successive section when said segments are mounted on said cylindrical surface of said drum.

17. An apparatus according to claim 16 wherein the drum engaging surface of the base section of each of said segments is provided with the radius of curvature substantially the same as the radius of said cylindrical surface of said drum.

18. An apparatus according to claim 9 wherein the drum engaging surface of the base section of each of said segments is provided with a radius of curvature substantially the same a radius of said cylindrical surface of said drum.

19. An apparatus according to claim 9 wherein said support means is mountable on the dipper stick of an excavating machine.

20. An apparatus according to claim 9 wherein said support means is mountable on a land vehicle as a wheel unit.

21. An apparatus according to claim 9 wherein said support means is attachable to a land vehicle for being towed thereby.

22. An apparatus according to claim 1 wherein said liner is formed of a material selected from a group consisting of polyethylene and polytetrafluoroethylene.

23. An apparatus according to claim 1 wherein said liner consists of a non-earth adhering polymer sprayed on said drum.
